(19) United States
(12) Patent Application Publication
(10) Pub. No.: US 2014/0369325 A1
(43) Pub. Date: Dec. 18, 2014

(54) TERMINAL AND METHOD FOR HANDLING TIMING REFERENCE IN A WIRELESS NETWORK

(71) Applicant: Telefonaktiebolaget L M Ericsson (publ), Stockholm (SE)

(72) Inventors: Mattias Bergstrom, Stockholm (SE); Lisa Bostrom, Solna (SE); Mikael Wittberg, Uppsala (SE)

(73) Assignee: Telefonaktiebolaget LM Ericsson (publ), Stockholm (SE)

(21) Appl. No.: 14/373,466

(22) PCT Filed: Dec. 21, 2012
(86) PCT No.: PCT/SE2012/051487

§ 371 Date: Jul. 21, 2014

Related U.S. Application Data
(60) Provisional application No. 61/591,610, filed on Jan. 27, 2012.

(51) Int. Cl. H04W 56/00; H04W 74/08; H04L 5/00

(52) U.S. Cl. CPC H04W 56/0005; H04L 5/0048; H04W 74/0833
USPC 370/336

(57) ABSTRACT

According to a first aspect of embodiments herein, the object is achieved by a method in a terminal for handling a timing reference. The terminal is served by multiple serving cells of a wireless network, and is configured with a first Timing Advance, TA, group comprising the multiple serving cells, one of which, a current TR cell, acts as the timing reference for the multiple serving cells. When the current TR cell becomes unavailable for the terminal, the terminal autonomously selects a new TR cell to act as the timing reference for the multiple serving cells in the TA group.

### TECHNICAL FIELD

Embodiments herein relates to a terminal and a method therein. The technical field of the present disclosure generally relates to uplink transmission in a wireless network. In particular, the technical field relates to handling of timing reference in a wireless network.

### BACKGROUND

Communication devices such as terminals are also known as e.g. User Equipments (UE), mobile terminals, wireless terminals and/or mobile stations. Terminals are enabled to communicate wirelessly in a cellular communications network or wireless communication systems, sometimes also referred to as cellular radio systems or cellular networks. The communication may be performed e.g. between two terminals, between a terminal and a regular telephone and/or between a terminal and a server via a Radio Access Network (RAN) and possibly one or more core networks, comprised within the cellular communications network.

Terminals may further be referred to as mobile telephones, mobile nodes, cellular telephones, laptops, or surf plates with wireless capability, just to mention some further examples. The terminals in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area is served by a base station, e.g. a Radio Base Station (RBS), which sometimes may be referred to as e.g. “eNB”, “eNodeB”, “NodeB”, “B node”, Base Transceiver Station (BTS), or AP (Access Point), depending on the technology and terminology used. The different cell areas may overlap each other geographically. The base stations may be of different classes such as e.g. macro eNodeB, home eNodeB or pico base station, based on transmission power and thereby also on cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the terminals within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3rd Generation Partnership Project (3GPP) Long Term Evolution (LTE), base stations, which may be referred to as eNodeBs or even eNBs, may be directly connected to one or more core networks.

UMTS is a third generation mobile communication system, which evolved from the GSM, and is intended to provide improved mobile communication services based on Wideband Code Division Multiple Access (WCDMA) access technology. UMTS Terrestrial Radio Access Network (UTRAN) is essentially a radio access network using wideband code division multiple access for terminals. The 3GPP has undertaken to evolve further the UTRAN and GSM based radio access network technologies.

3GPP LTE radio access standard has been written in order to support high bitrates and low latency both for uplink and downlink traffic. All data transmission is in LTE controlled by the radio base station.

LTE uses Orthogonal Frequency Division Multiplexing (OFDM) in DL and Discrete Fourier Transform (DFT)-spread OFDM in UL. A basic LTE DL physical resource can thus be seen as a time-frequency grid, where each resource element in the time-frequency grid corresponds to one OFDM subcarrier during one OFDM symbol interval.

In the time domain, LTE DL transmissions are organized into radio frames of 10 ms, each radio frame comprising ten equally-sized subframes of a length of 1 ms.

Resource allocation in LTE is typically described in terms of Resource Blocks (RB), where a resource block corresponds to one slot, 0.5 ms, in the time domain and 12 contiguous subcarriers in the frequency domain. A pair of two adjacent resource blocks in time direction, 1.0 ms, is referred to as a resource block pair. Resource blocks are numbered in the frequency domain, starting with 0 from one end of the system bandwidth.

The notion of Virtual Resource Blocks (VRB) and Physical Resource Blocks (PRB) have been introduced in LTE. The actual resource allocation to a terminal is made in terms of VRB pairs. There are two types of resource allocations, localized and distributed. In localized resource allocation, a VRB pair is directly mapped to a PRB pair, hence two consecutive, localized VRBs are also placed as consecutive PRBs in the frequency domain. However, the distributed VRBs are not mapped to consecutive PRBs in the frequency domain, thereby providing frequency diversity for a data channel transmitted using these distributed VRBs.

DL transmissions are dynamically scheduled, i.e., in each subframe, the base station transmits control information about to which terminals data is transmitted and upon which resource blocks the data is transmitted, in the current DL subframe. This control signaling is typically transmitted in the first 1, 2, 3 or 4 OFDM symbols in each subframe and the number n=1, 2, 3 or 4 is known as the Control Format Indicator (CFI). The DL subframe also contains Common Reference Symbols (CRS), which are known to the receiver and used for coherent demodulation of e.g. the control information.

Carrier Aggregation

The LTE Release 10 specifications have recently been standardized, supporting Component Carrier (CC) bandwidths up to 20 MHz which is the maximal LTE Release 8 carrier bandwidth. Hence, an LTE Release 10 operation wider than 20 MHz is possible and appear as a number of LTE carriers to an LTE Release 10 terminal.

In particular for early LTE Release 10 deployments, it may be expected that there will be a smaller number of LTE Release 10 capable terminals compared to many LTE legacy terminals. Therefore, it is necessary to assure an efficient use of a wide carrier also for legacy terminals, i.e. that it shall be possible to implement carriers where legacy terminals can be scheduled in all parts of the wideband LTE Release 10 carrier. One straightforward way to obtain this is through Carrier Aggregation (CA). CA implies that an LTE Release 10 terminal can receive multiple CCs, where the CCs have, or at least have the possibility to have, the same structure as a Release 8 carrier. One example is an aggregated bandwidth of 100 MHz being divided into five 20 MHz bands so that an LTE Release 10 can use all five bands, i.e. 100 MHz, and a legacy terminal, e.g. an LTE Release 8 terminal can use one of the five 20 MHz bands, i.e. 20 MHz. The LTE Release 10 standards support up to 5 aggregated carriers where each carrier is limited in the Radio Frequency (RF) specifications to have one of six bandwidths namely 6, 15, 25, 50, 75 or 100 RB corresponding to 1.4, 3, 5, 10, 15 and 20 MHz respectively.

The number of aggregated CC as well as the bandwidth of the individual CC may be different for UL and DL. A symmetric configuration refers to a situation where the numbers of CCs in the DL and UL are the same, whereas an asymmetric configuration refers to a situation where the numbers are different. It is important to note that the number of CCs configured in the wireless network may be different from the number of CCs seen by a terminal. For example, a terminal may support more DL CCs than UL CCs, even though the network offers the same number of UL and DL CCs.

During initial access, an LTE Release 10 terminal behaves similar to an LTE Release 8 terminal. Upon successful connection to the wireless network, a terminal may, depending on its own capabilities and the wireless network, be configured with additional CCs in the UL and the DL. Configuration is based on Radio Resource Control (RRC). Due to the heavy signalling and a rather slow speed of RRC signalling, it is envisioned that a terminal may be configured with multiple CCs even though not all of them are currently used. If a terminal is activated on multiple CCs, this implies that the terminal has to monitor all DL CCs for Physical Downlink Control Channel (PDCCH) and Physical Downlink Shared Channel (PDSCH). This implies a wider receiver bandwidth, higher sampling rates, etc. resulting in high power consumption.

Uplink Time Alignment

In order to preserve UL orthogonality, the UL transmissions from multiple terminals need to be UL time aligned at the base station reception. Since the terminals may be located at different distances from the base station, the terminals will need to initiate their UL transmissions at different times. This is since it takes longer time for the transmission to reach the base station if a terminal is far from the base station, e.g. at the cell edge, than it takes if a terminal is close to the base station. Thus a terminal far from the base station needs to start transmission earlier than a terminal close to the base station. This can for example be handled by time advance of the UL transmissions. This means that a terminal starts its UL transmission before a nominal time given by the timing of the DL signal received by the terminal. This concept is illustrated in FIG. 1. FIG. 1 discloses timing advance of UL transmissions based on distance to a base station referred to as eNodeB in FIG. 1.

The UL timing advance, which is based on the measurements on the UL transmission from the terminal, is maintained by the base station through Timing Advance Commands (TAC). A first TAC is sent as part of a random access response message. Subsequent TACs are sent as Medium Access Control (MAC) control elements.

Through the subsequent TACs, the terminal is ordered to start its UL transmissions earlier or later than the nominal time. This UL transmission timing applies to all UL transmissions except for random access preamble transmissions on Physical Random Access Channel PRACH, i.e. including transmissions on Physical Uplink Shared Channel (PUSCH), Physical Uplink Control Channel (PUCCH), and Sounding Reference Signal (SRS).

There is a relationship between DL transmissions and the corresponding UL transmission. Examples include a timing between a DL-Shared Channel (SCH) transmission on PDSCH and a Hybrid Automatic Repeat Request (HARQ) Acknowledgement/Non-Acknowledgement (ACK)/(NACK) feedback transmitted in UL either on PUCCH or PUSCH. Examples further include the timing between an UL grant transmission on PDCCH and the UL-SCH transmission on PUSCH.

When a Timing Advance (TA) value for a terminal increases, the terminal processing time between the DL transmission and the corresponding UL transmission decreases. For this reason, an upper limit on the maximum timing advance has been defined by 3GPP in order to set a lower limit on the processing time available for a terminal. For LTE, this value has been set to roughly 667 microseconds (ms) which corresponds to a cell range of 100 km. Note that the TA value compensates for the round trip delay, i.e. the total delay in UL and DL.

In LTE Release 10, there is only a single TA value per terminal and the terminal is assumed to have the same transmission timing for all its UL cells. The reference point for the timing advance is the receive timing of the primary DL cell. This limits the possible CA deployment scenarios for the UL as described in 3GPP 36.300, Release 10, Annex J.1.

In LTE Release 11, different serving cells used by the same terminal may have different timing advances. The serving cells sharing the same TA value, for example depending on the deployment, will be configured by the wireless network to belong to a so called Timing Advance group (TA group). If at least one serving cell of the TA group is UL time aligned, all serving cells belonging to the same group may use this TA value. To obtain a UL time alignment for a Secondary serving cell (SCell) belonging to a different TA group than the Primary serving Cell (PCell), the current 3GPP assumption is that network initiated random access, i.e. the network tells the terminal to perform random access, may be used to obtain the initial TA for this SCell. The same TA value can then be applied for all serving cells of the TA group this SCell belongs to.

A Primary Cell is a cell operating on the primary frequency, in which the terminal either performs an initial connection establishment procedure or initiates a connection re-establishment procedure, or a cell indicated as the primary cell in the handover procedure.

A Secondary Cell is a cell, operating on a secondary frequency, which may be configured once an RRC connection is established and which may be used to provide additional radio resources.

Regarding a Serving Cell, for a terminal in RRC connected state, i.e. in RRC_CONNECTED, not configured with CA there is only one serving cell comprising the primary cell. For a terminal in RRC connected state, i.e. in RRC_CONNECTED configured with CA the term ‘serving cells’ is used to denote the set of one or more cells comprising its primary cell and all secondary cells.

For each TA group there is an associated Time Alignment Timer (TAT) which is started when the terminal performs random access to a serving cell of the TA group and is thereby assigned its first TA value. The TAT is then restarted each time the TA value used by the TA group is updated, e.g. upon reception of a TAC. A serving cell is considered UL time aligned when the associated TAT is running. If the serving cell is activated, then a terminal can transmit in the UL on the serving cell. When the TAT expires, the terminal cannot perform UL transmission on the serving cells associated with that TAT except for random access.

In LTE Release 11, new UL carrier aggregation scenarios are supported compared to Release 10, some of which require multiple TA values due to aggregation of UL cells from different physical locations or UL cells in which transmissions paths have different routes from the terminal to the base station. A TA value tells a terminal when it should start a UL subframe transmission relative to a timing reference. This timing reference has in earlier releases been the time of DL reception of the subframe start on the PCell at the terminal. A terminal starts transmitting the UL subframe on cell i at time TAi seconds before the timing reference for cell i. In Release 11, it is currently being discussed which timing reference that should be used now that multiple TA values are to be handled for one terminal.

### SUMMARY

It is therefore an object of embodiments herein to provide a way of improving the handling of timing references for multiple serving cells in a wireless network.

According to a first aspect of embodiments herein, the object is achieved by a method in a terminal for handling a timing reference. The terminal is served by multiple serving cells of a wireless network. The terminal is configured with a first Timing Advance, TA, group comprising the multiple serving cells, one of which, a current Timing Reference cell, TR cell, also referred to as a first serving cell, acts as the timing reference for the multiple serving cells. When the current TR cell becomes unavailable for the terminal, the terminal autonomously selects a new TR cell, also referred to as a second serving cell, to act as the timing reference for the multiple serving cells in the TA group. The TA group may also be referred to as the first TA group.

According to a second aspect of embodiments herein, the object is achieved by a terminal for handling a timing reference. The terminal is served by multiple serving cells of a wireless network. The terminal is configured with a first Timing Advance, TA, group comprising the multiple serving cells, one of which, a current Timing Reference cell, TR cell, acts as the timing reference for the multiple serving cells. The terminal comprises a timing reference selector configured to, when the current TR cell becomes unavailable for the terminal, autonomously select a new TR cell to act as the timing reference for the multiple serving cells in the TA group.

Since the terminal autonomously selects a new TR cell to act as the timing reference for the multiple serving cells in the TA group, no random access needs to be performed. In this way the handling of timing reference and the performance of the wireless network is improved.

One advantage of embodiments herein is that the terminal will not consider the serving cells in a TA group UL time aligned if the serving cell which served as the timing reference for the TA group is deconfigured or removed from the TA group. Therefore interference can be avoided.

If the terminal does not have a valid timing reference, the UL transmission timing will be uncertain, and probably wrong. The UL signals will therefore not be orthogonal to other terminals' signals hence interference will be created which degrades performance or even makes decoding of the signals impossible.

### BRIEF DESCRIPTION OF THE DRAWINGS

Examples of embodiments herein are described in more detail with reference to attached drawings in which:

FIG. 1 is a schematic block diagram illustrating timing advance of UL transmissions.

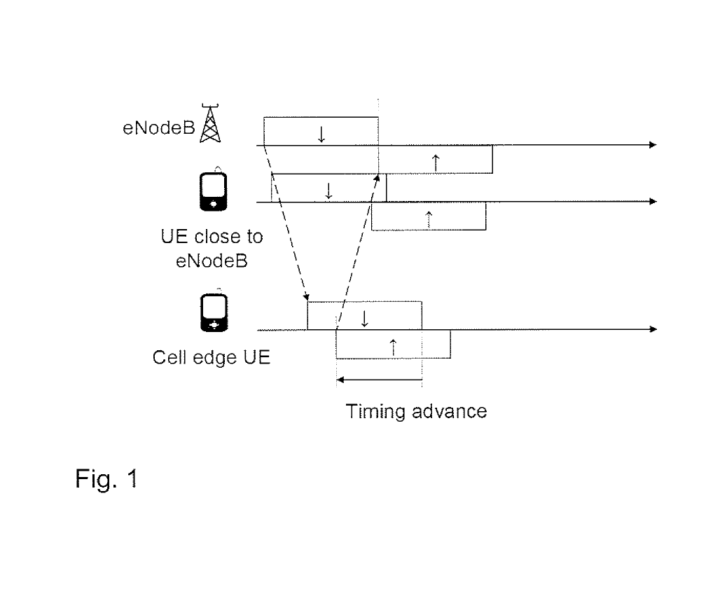

FIG. 2 is a schematic block diagram illustrating embodiments of a wireless network.

FIG. 3a,b are schematic block diagrams illustrating a scenario.

FIG. 4 is a flowchart depicting embodiments of a method in a terminal.

FIG. 5 is flowchart depicting examples of embodiments herein

FIG. 6 is flowchart depicting examples of embodiments herein.

FIG. 7 is flowchart depicting examples of embodiments herein.

FIG. 8 is a schematic block diagram illustrating embodiments of a terminal.

FIG. 9 is a schematic block diagram illustrating embodiments of a terminal.

FIG. 10 is a schematic block diagram illustrating embodiments of a network node.

FIG. 11 is a schematic block diagram illustrating embodiments of a network node.

### DETAILED DESCRIPTION

As part of developing embodiments herein, a problem will first be identified and discussed.

A network such as e.g. a wireless network configures to which TA group an SCell belongs, and the wireless network may also move an SCell from one TA group to another. The PCell can however not change TA group in Release 11.

It is currently discussed in 3GPP Radio Access Network Working Group 2 (RAN2) what should be the timing reference for the SCells that do not belong to the TA group comprising the PCell. It has been agreed that each TA group not comprising the PCell, one SCell should be selected which should be used as timing reference for all SCells in this TA group. For all SCells in a TA group, the transmission of the UL subframe starts with a fixed offset, namely the TA value for this TA group, relative the reception of the DL subframe start on the SCell used as the timing reference for this TA group. It has been agreed that in each TA group not comprising the PCell, the SCell in the TA group to which the terminal performed the latest successful random access procedure should be used as timing reference for all SCells in that TA group.

If the SCell which acts as timing reference in a TA group not comprising the PCell becomes deactivated, deconfigured or removed from the TA group while there remains other activated SCells in that TA group, the remaining SCells in the TA group will not have a valid timing reference. To be deconfigured means for the SCell to be removed from the terminal's configuration, i.e. it is no longer a serving cell for the terminal. This means that from the terminals point of view, deconfigured cells do not exist. To select a new timing reference, a random access procedure needs to be performed on one of the remaining activated SCells. Between the time that the SCell which acted as the timing reference gets deactivated, deconfigured or removed from the TA group until the time that a new SCell is selected as the timing reference, the SCells in the TA group will not have any timing reference. Without a valid timing reference, the SCells might get out of synchronization which could lead to interferences in the system as well as decoding difficulties of the UL signals in the base station.

A problem is how to handle this “in-between” time between timing references, or more importantly how to avoid the terminal from transmitting in the UL during this period of time. If the terminal does not have a valid timing reference, the UL transmission timing will be uncertain, and probably wrong. The UL signals will therefore not be orthogonal to other terminals' signals hence interference will be created which degrades performance or even makes decoding of the signals impossible.

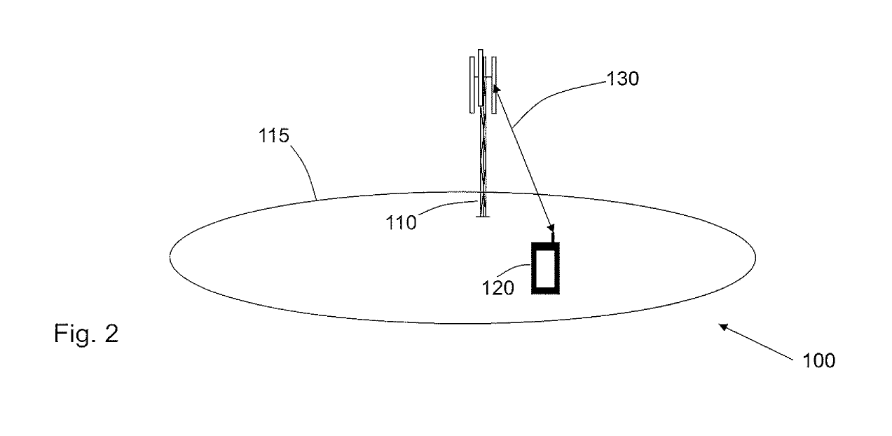

FIG. 2 depicts a wireless network 100 in which embodiments herein may be implemented. The wireless network 100 is a wireless communication network such as an LTE, WCDMA, GSM network, any 3GPP cellular network, Wimax, or any cellular network or system.

Although terminologies from 3rd-Generation Partnership Project (3GPP) are used in this disclosure for explanation purposes, this should not be seen as limiting the scope of the disclosed subject matter. Other wireless systems, such as Worldwide Interoperability for Microwave Access (WiMax), Ultra Mobile Broadband (UMB), Global System for Mobile Communication (GSM) and others may benefit from exploiting the ideas covered within this disclosure.

The wireless network 100 comprises a plurality of base stations whereof one, a base station 110 is depicted in FIG. 2. The base station 110 may be a Radio Base Station (RBS) such as e.g. a NodeB, an eNB, an eNodeB, or a Home Node B, a Home eNode B or any other network node capable to serve a user equipment such as a terminal or a machine type communication device in a wireless network. The base station 110 is serving a cell 115.

In the embodiments described below, terms “base station” and “terminal” will be used in a generic sense, and thus should not be taken to be limiting. The base station represents the network side providing services to the terminal. Also note that one or a combination of network nodes including the core network nodes may be involved in providing the services.

A number of terminals are located in the cell 115 served by the base station 110. In the example scenario of FIG. 2, only one terminal referred to as terminal 120, is shown in the cell 115. The terminal 120 is capable of accessing the wireless network 100 via the base station 110 using a radio link 130, when the terminal 120 is located in the cell 115. The terminal 120 may e.g. be a terminal, a mobile terminal or a wireless terminal, a mobile phone, a computer such as e.g. a laptop, a Personal Digital Assistant (PDAs) or a tablet computer, sometimes referred to as a surf plate, with wireless capability, or any other radio network unit capable to communicate over a radio link in the wireless network 100.

Generically, the terminal is used to represent devices that receive services from the wireless network 100, from serving cells. In one aspect, whether or not a cell is a serving cell is from the perspective of the terminal. Also, unless explicitly indicated, no distinction should be drawn between whether a cell providing services is a primary serving cell or secondary serving cell.

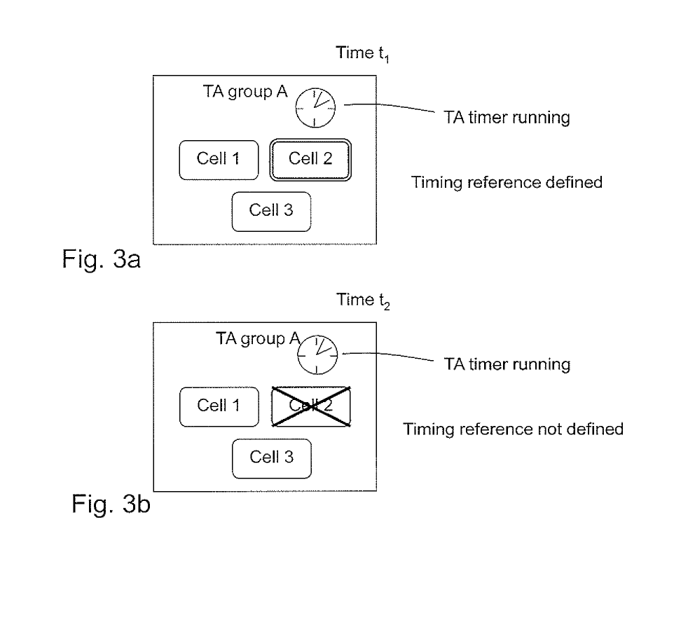

For the purposes of this document, the following is assumed. A network such as the wireless network 100, serves one or more terminals such as the terminal 120. The wireless network 100 comprises a plurality of cells. A terminal can be served by one or more cells which are then referred to as serving cells for that terminal. The terminals' serving cells are grouped into one or more TA groups. Each TA group comprises one or more of the serving cells of the terminal 120. In each TA group, a serving cell in that TA group functions as a timing reference for the group. Such cell is referred to as a Timing Reference (TR) cell for that TA group. See for example FIG. 3a, wherein a TA group comprises three cells, Cell 1, Cell 2, and Cell 3. In FIG. 3a, Cell 2 functions as a timing reference for the TA group. Note that each TA group may be terminal specific. That is, the network may have configured a first terminal to have cell X as serving cell and belong to a TA group with cell index A and a second terminal to have cell X as serving cell but belong to a TA group with cell index B. So, from the network side, a cell may belong to two different TA groups used by two different terminals.

The terminal 120 may comprise one or more TA groups whereof at least the TA groups with member cells provides service to the terminal 120. The terminal 120 may also maintain member cells of each TA group in the list. Further, the terminal 120 may comprise one or more TA timers in which each timer is associated with one of the TA groups. See FIG. 3a.

In one or more aspects, the terminal 120 is allowed to perform a UL transmission on serving cells in a TA group when the serving cells of that TA group are UL time aligned (or simply “time aligned”). For the purposes of this document, when at least one serving cell of a TA group is time aligned, then all other serving cells of the group are considered time aligned, and hence the TA group will be referred to as being time aligned. Then it can be said that the UL transmission may occur on the cells in a TA group when that TA group is time aligned. When the TA group is not time aligned, the terminal 120 does not perform UL transmissions on the serving cells of that TA group.

In one aspect, a TA group is determined to be time aligned when both of the following conditions are satisfied.

(1) The time alignment timer (TAT) associated with the TA group is running; and

(2) There is a TR cell for the TA group, i.e., there is a valid timing reference. It may be required that the TR cell is active for this condition to be satisfied.

If one or both conditions (1) and (2) are not satisfied, the terminal 120 determines the TA group as not being time aligned, and thus is not allowed to perform UL transmission on the serving cells of the TA group.

If a serving cell is not considered UL time aligned after losing its timing reference, UL transmissions, aside from random access preambles, are not allowed, and therefore the interference and decoding problems mentioned above will not occur.

In another aspect and according to embodiments herein, the terminal 120 performs an autonomous TR cell reselection when a current TR cell of the TA group becomes unavailable. In this way, a valid timing reference is quickly established.

In yet another aspect, the network such as e.g. base station 110 performs a TR cell reselection for a TA group and informs the terminal 120.

One or more non-limiting aspects of the disclosed subject matter address some or all of the issues described above with respect to the conventional solutions. The duration between the timing references will be referred to as “in-between” time. In one aspect, a terminal 120 does not transmit on the UL on the serving cells of the TA group during the in-between time. In another aspect, the terminal 120 avoids the in-between time by applying a new timing reference immediately or substantially immediately. For example, the new timing reference can be applied without performing the random access.

Note that in some context, cells can be understood as resources such as carriers. Hence, a terminal can “transmit on” the cells. In another context, cells can be understood as network entities that provide services to the terminals. For example, the terminal 120 may communicate with one or more cells of the network.

Without loss of generality, one or more aspects of the subject matter are described in detail for explanation purposes. They are not intended to be limiting.

In one or more embodiments, the terminal 120 does not perform, or is otherwise prevented from performing, UL transmissions on the cells in a TA group when there is no valid timing reference for the group. This can happen when the TR cell of a TA group becomes unavailable.

For explanation of one or more embodiments, an example event flow is illustrated in FIG. 3a and b.

In FIG. 3a, the following is assumed:
At time t₁,
The TA group includes as members Cell 1, Cell 2 and Cell 3;
Cell 2 is the TR cell; and
Associated TA timer is running;

In FIG. 3b, the following is assumed:
At time t₂, Cell 2 which is the TR cell becomes unavailable, e.g., through deconfiguration or removal from the TA group, etc.

According to embodiments herein, the terminal 120 switches to a new timing reference when the current timing reference is lost. For example, when the current TR cell becomes unavailable, the terminal 120 performs an autonomous reselection to find a serving cell to act as the new TR cell for the serving cells in the TA group.

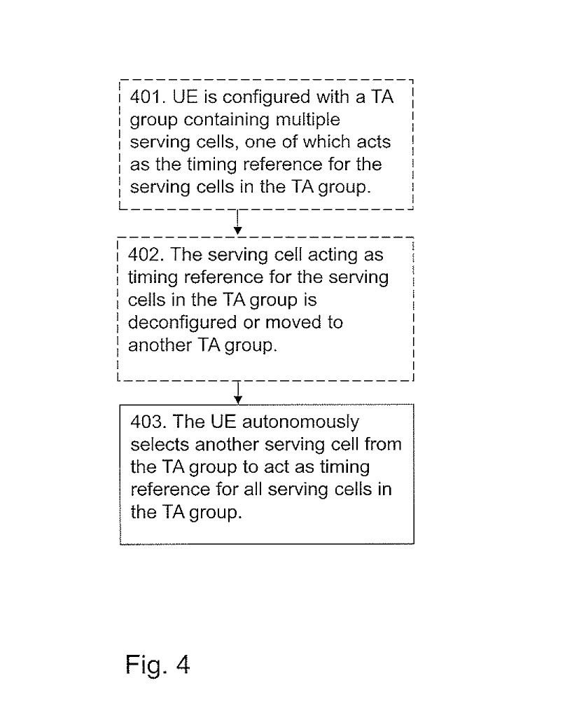

Example of embodiments of a method in the in the terminal 120 for handling a timing reference, will now be described with reference to a flowchart depicted in FIG. 4. The terminal 120 is served by multiple serving cells of the wireless network 100. The method comprises the following actions, which actions may be taken in any suitable order. The actions according to this method and method actions according to embodiments below, are referred to as boxes with broken lines if the action is optional and only relates to some of the embodiments.

Action 401

The terminal 120 is configured with a TA group comprising multiple serving cells. One of them, a current TR cell, acts as the timing reference for the multiple serving cells. This may be according to the example in FIG. 3a wherein the TA group comprises Cell 1, Cell 2 and Cell 3 and wherein the current TR cell is Cell 2. As mentioned above, the TA group may also be referred to as a first TA group.

Action 402

In this action, the current TR cell becomes unavailable for the terminal 120. This is e.g. according to the example in FIG. 3b wherein the TA group comprises Cell 1, Cell 2 and Cell 3 and wherein the current TR cell is Cell 2 that becomes unavailable. In some embodiments, the current TR cell becomes unavailable for the terminal 120 through deconfiguration, removal from the TA group, or deactivation.

A serving cell of a TA group, including the TR cell of the group, may become unavailable in multiple ways. For example, a serving cell may be deconfigured or removed from a TA group. Deconfiguration of a serving cell means that the terminal 120 no longer can utilize the cell. In this situation, the terminal 120 is notified by the base station 110 or the network that the cell cannot be utilized or is deconfigured. The cell is then removed from the list of cells that the terminal 120 uses. In the context of this disclosure, removal from a group includes a reconfiguration of the cell's group association. The base station 110 or the network may be reconfigured so as to associate a serving cell C from being a member of TA group X to being a member of TA group Y. In this scenario, the serving cell C is removed from TA group X. If the serving cell C happened to be the TR cell of TA group X, this reconfiguration effectively removes the TR cell from TA group X.

A deactivated cell also may be considered as unavailable in one aspect. The activation state of a cell is typically terminal specific. That is, a cell can be deactivated for one specific terminal, meaning that this specific terminal will no longer use this cell. From the wireless network's perspective, the same cell can be up and running, and other terminals may still be using the cell. According to another aspect, a cell may be deactivated but still function as the timing reference. Thus, depending on the implementation, a deactivation of a TR cell need not necessarily imply unavailability.

Action 403

When the current TR cell becomes unavailable for the terminal 120, the terminal 120 autonomously selects a new TR cell to act as the timing reference for the multiple serving cells in the TA group. The problem of the scenario illustrated in FIG. 3b may be resolved. In this embodiment, the terminal 120 selects either Cell 1 or Cell 3 as timing reference for the TA group upon losing Cell 2, and the terminal 120 would therefore have a timing reference for the serving cells in the group also after time t2.

Preferably, the terminal 120 performs the reselection immediately upon loss of the current TR, hence ensuring that no “gap” or “in-between” time exists when switching to the new TR. It may also be so that the terminal has proactively performed the selection of which serving cell to use as TR cell in case the currently used TR cell becomes unavailable.

In one scenario, the selected new TR belongs to the TA group which it is selected to be TR cell for. In another possible scenario, the new TR cell belongs to another TA group, for example a TR cell in the TA group to which the primary cell (PCell) belongs to. Thus the new TR cell may be a cell belonging to the TA group or to another TA group, such as a second TA group. The new TR cell may be a cell acting as timing reference in the TA group to which the primary serving cell belongs.

In some embodiments, the selection of the new TR cell may be based on unique cell identifiers of the respective serving cells still associated with the TA group. In some embodiments, the unique cell identifier comprises a cell index. In these embodiments the serving cell with the lowest or highest cell index may be selected as the new TR cell. Thus the terminal 120 may reselects the timing reference cell, i.e. the new TR cell for the TA group based on the lowest, alternatively highest cell index or other unique identifiers, among the serving cells still associated with the TA group. In one scenario of these embodiments, only activated serving cells are considered for being selected as the TR cell. Thus in some embodiments, only activated serving cells are considered for being selected as the new TR cell.

Since the cell indices or other identities of the serving cells are known also by the wireless network 100, the wireless network 100 will know which serving cell is the new timing reference, i.e. the new TR cell. But in another scenario, a deactivated cell may be selected as the TR cell, i.e. the new TR cell. These embodiments is a part of the autonomous reselection process the terminal 120 performs as described above. For example, the cell with the lowest or highest cell index is the new TR cell, i.e. new TR cell, and thus performing random access to achieve a timing reference can be avoided.

In some embodiments, the timing reference is for uplink transmissions on the multiple serving cells. In these embodiments, the terminal 120 may perform uplink transmissions in accordance with the selected timing reference.

Below some further examples of embodiments will be described.

According to some embodiments, a method in the terminal 120 for handling a timing reference is provided. The terminal 120 is configured with a first Timing Advance, TA, group comprising multiple serving cells, one of which, a current TR cell, acts as the timing reference for the multiple serving cells, which multiple serving cells serve the terminal 120, and which multiple serving cells are comprised in a wireless network 100, the method comprising:

when the current TR cell becomes unavailable for the terminal (120) performing any one or more actions out of:
either stopping (Action 503 below) a TA timer in the terminal 120 or considering (Action 703 below) the TA timer to be expired, which TA timer is associated with the TA group, or
considering (Action 603 below) all cells in the TA group as not being UL time aligned.

In some embodiments, the current TR cell becomes unavailable for the terminal 120 through deconfiguration, removal from the TA group, or deactivation.

In some embodiments, the method further comprises:
performing a random access on one of the remaining activated serving cells of the TA group to receive a TAC which starts the TA timer.

In some embodiments, the method further comprises:
receiving a TAC MAC CE from the network such as the base station 110 which starts the TA timer.

In case the TA timer has been stopped by the terminal 120 as above, that does not necessarily mean that the TA value is not valid, hence if the TA value is valid the network may send a TAC MAC CE with a delta-value 0 which the terminal 120 would apply, resulting in the same TA value as before (X+0=X), and this would then restart the TAT and UL transmissions could resumed.

In some embodiments, the method further comprises:
autonomously selecting a new TR cell to act as the timing reference for the multiple serving cells in the TA group.

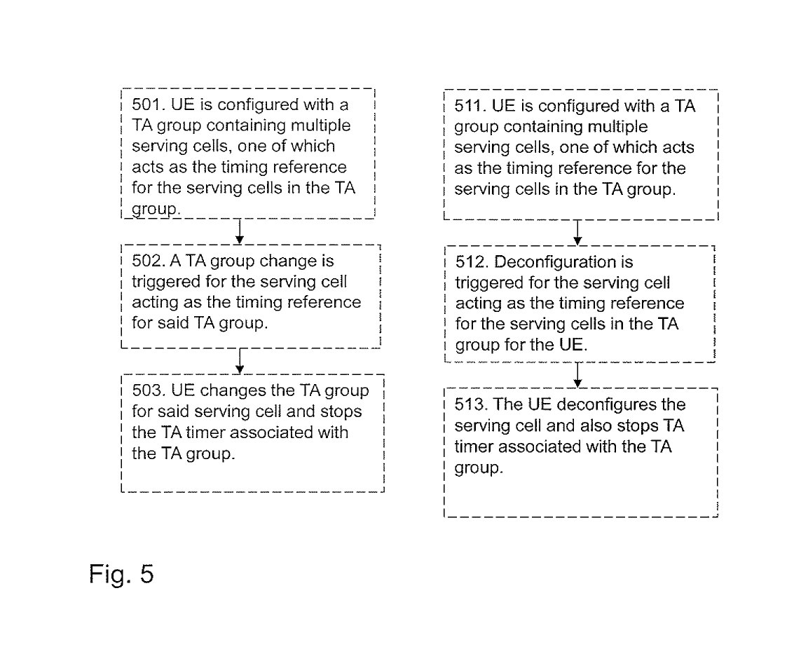

In a first embodiment, the terminal 120 stops a TA timer associated with the TA group upon the TR cell of said TA group becoming unavailable. Example flow charts of this first embodiment are illustrated in FIG. 5. These are examples and should not be taken in a limiting sense. The left flow chart with actions 501-503 may be performed when the current TR cell is removed, e.g., reconfigured so that group association is changed.

Action 501. In this action the UE, i.e. the terminal 120 is configured with a TA group comprising multiple serving cells, one of which acts as the timing reference for the multiple serving cells in the TA group.

Action 502. A TA group change is triggered for the current TR cell acting as the timing reference for said TA group. It should be noted that this is just an example of how the TR cell may become unavailable.

Action 503. The UE, i.e. the terminal 120 changes the TA group for said current TR cell and stops the TA timer associated with the TA group.

The right flow chart with actions 511-513 may be performed when the current TR cell is deconfigured.

Action 511. The UE, i.e. the terminal 120 is configured with a TA group comprising multiple serving cells, one of which acts as the timing reference for the multiple serving cells in the TA group.

Action 512. Deconfiguration is triggered for the current TR cell, acting as the timing reference for the serving cells in the TA group for the UE, i.e. the terminal 120. It should be noted that this is just an example of how the TR cell may become unavailable.

Action 513. The UE, i.e. the terminal 120 deconfigures the serving cell and also stops TA timer associated with the TA group.

The problem of the scenario illustrated in FIG. 3a and b may be resolved by implementing a solution according to this first embodiment. In this first embodiment, the terminal 120 stops the TA timer for the TA group when the current cell, i.e. Cell 2 becomes unavailable at time t2. As described above, the condition (1) needs to be satisfied in order for the TA group to be time aligned. When the TA timer is stopped at time t2, the conditions (1) and (2) are no longer satisfied. Hence, the terminal 120 determines that the TA group is not time aligned. In other words, the terminal 120 determines that both Cells 1 and 3 are not time aligned at time t2.

Since the TA group is not time aligned, the terminal 120 does not perform UL transmissions on the serving cells of the TA group. This ensures that all UL transmission is stopped for all activated serving cells belonging to this TA group for the terminal 120, and thus avoids problems such as interferences and decoding difficulties as described above.

To regain UL time alignment for this TA group, a random access may be performed on one of the remaining activated serving cells, i.e., Cell 1 or Cell 3, of the TA group in order to receive a TAC which starts the TA timer. Alternatively, the terminal may select one of the remaining cells, as the new TR Cell without performing random access. This may for example be performed autonomously, by a set of pre-defined rules or upon order from the wireless network.

When the TA timer has been stopped a TAC has to be received to start it again. This means that a random access procedure has to be performed or a Time Advance Command MAC control element has to be received. So this alternative, i.e. to select another TR cell is not sufficient on its own to get the TA timer running again. But as the old TR cell has become unavailable the terminal may also require to select a new TR cell as well, unless the old TR has become available again at the time when UL time alignment is to be achieved.

In some embodiments, an alternative is to also start the TA timer upon TR reselection.

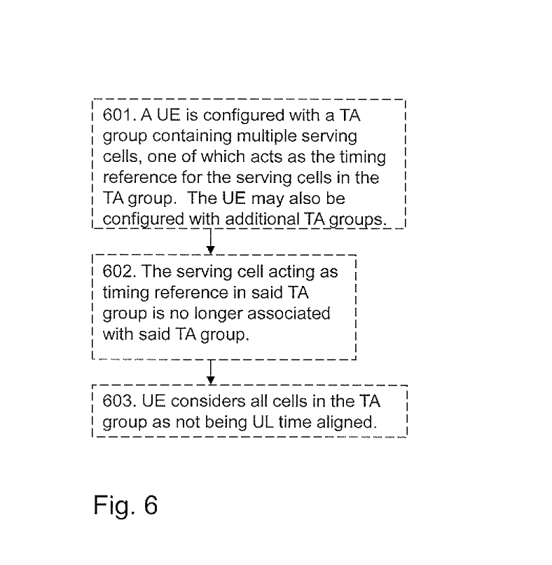

In a second embodiment, the terminal 120 applies both conditions (1) and (2) to determine whether or not the TA group is time aligned upon the TR cell of said TA group becoming unavailable. One difference from the first embodiment is that the TA timer is not necessarily stopped in the second embodiment when the TR cell, i.e. the current TR cell, becomes unavailable. An example flow chart of the second embodiment is illustrated in FIG. 6.

Action 601. The UE, i.e. the terminal 120 is configured with a TA group comprising multiple serving cells, one of which acts as the timing reference for the multiple serving cells in the TA group. The UE may also be configured with additional TA groups.

Action 602. The current TR cell acting as timing reference in said TA group is no longer associated with said TA group. It should be noted that this is just an example of how the TR cell may become unavailable.

Action 603. The UE, i.e. the terminal 120 considers all cells in the TA group as not being UL time aligned. I.e. the TA group is not UL time aligned.

The problem of the scenario illustrated in FIG. 3 may be resolved by implementing a solution according to this second embodiment. As described above, both conditions (1) and (2) need to be satisfied in order for the TA group to be time aligned. In the second embodiment, at time t2, the terminal 120 determines that condition (2) is no longer satisfied since Cell 2, i.e. the current TR cell, is unavailable. Hence, the terminal 120 determines that the TA group is not time aligned at time t2.

Since the TA group is not time aligned at time t2 in this second embodiment, the terminal 120 does not perform UL transmissions on the serving cells belonging to the TA group. This ensures that all UL transmission is stopped for all serving cells belonging to this group, and thus avoids problems such as interferences and decoding difficulties as described above.

To regain UL time alignment for this TA group, the terminal 120 may autonomously select one of the remaining cells as the new TR Cell without performing random access.

When a valid timing reference is re-established, e.g., by selection of a new TR cell, i.e. the new TR cell, the terminal 120 may resume UL transmissions as long as the associated TA timer is still running. If the TA timer is no longer running, UL transmissions may not be resumed even with a valid timing reference. Note that the new TR cell, may be the same as the old TR cell, i.e. the cell referred to as the current TR cell herein, or may be a different cell of the TA group. For example, the old TR cell, i.e. the current TR cell, may become available at a later point in time to be used as a TR cell, i.e. the new TR cell.

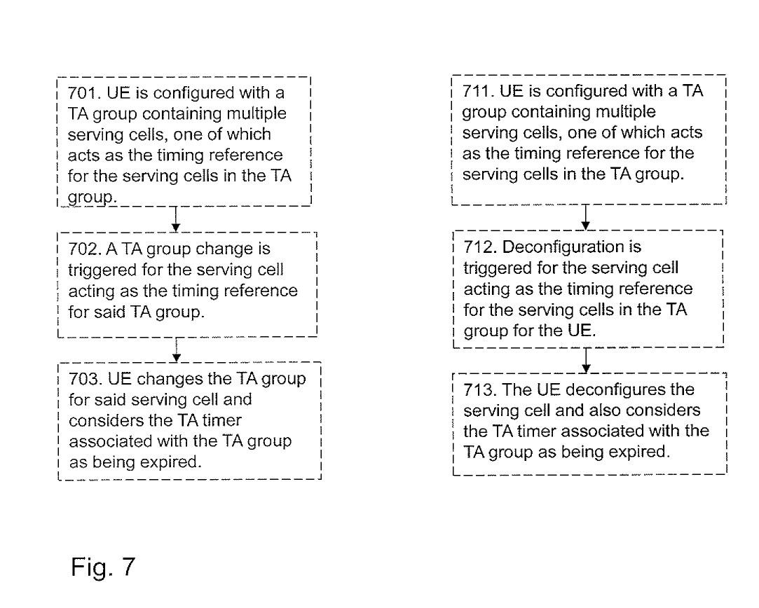

In a third embodiment, for the most part, the behavior of the third embodiment is similar to the first embodiment when there is no valid timing reference, e.g., because current TR cell becomes unavailable. One difference is that in this third embodiment, the terminal 120 considers the TA timer to be expired instead of actually stopping the timer. Upon such consideration, the terminal 120 may take actions such as clearing HARQ buffers, clearing downlink assignment assignments and UL grants, and notifying RRC to release resources such as PUCCH and SRS. Example flow charts of the third embodiment according to a first alternative, Actions 701-703 and according to a second alternative, actions 711-713 are illustrated in FIG. 7.

Action 701. The UE, i.e. the terminal 120, is configured with a TA group comprising multiple serving cells, one of which acts as the timing reference for the multiple serving cells in the TA group.

Action 702. In the first alternative, a TA group change is triggered for the current TR cell acting as the timing reference for said TA group. It should be noted that this is just an example of how the TR cell may become unavailable.

Action 703. In the first alternative, the UE, i.e. the terminal 120 changes the TA group for said serving cell to another TA group, and considers the TA timer associated with the TA group as being expired.

Action 711. The UE i.e. the terminal 120, is configured with a TA group comprising multiple serving cells, one of which acts as the timing reference for the multiple serving cells in the TA group.

Action 712. In the second alternative, deconfiguration is triggered for the current TR cell acting as the timing reference for the serving cells in the TA group for the terminal 120.

Action 713. In the second alternative, the UE i.e. the terminal 120, deconfigures the current TR cell and also considers the TA timer associated with the TA group as being expired.

The problem of the scenario illustrated in FIG. 3a and b may be resolved by implementing a solution according to the third embodiment. In this third embodiment, the terminal 120 considers the TA timer as being expired when Cell 2, i.e. the current TR cell, becomes unavailable at time t2. As such, the condition (1) is no longer considered to be satisfied. Hence, the terminal 120 determines that the TA group is not time aligned, and does not perform UL transmissions on the serving cells of the TA group.

To regain UL time alignment for this TA group, a random access may be performed on one of the remaining activated serving cells, i.e., Cell 1 or Cell 3, of the TA group in order to receive a TAC which starts the TA timer. Alternatively, the terminal may select one of the remaining cells, as the new TR Cell without performing random access. This may for example be performed autonomously, by a set of pre-defined rules or upon order from the wireless network.

When the TA timer has been stopped a TAC has to be received to start it again. This means that a random access procedure has to be performed or a Time Advance Command MAC control element has to be received. So this alternative, i.e. to select another TR cell is not sufficient on its own to get the TA timer running again. But as the old TR cell has become unavailable the terminal may also require to select a new TR cell as well, unless the old TR has become available again at the time when UL time alignment is to be achieved.

In some embodiments, an alternative is to also start the TA timer upon TR reselection.

The terminal 120 may reselect the timing reference cell, i.e. the new TR cell for the TA group based on the lowest, alternatively highest, cell index or other unique identifier, among the serving cells still associated with said TA group. In one scenario of these embodiments, only activated serving cells are considered for being selected as the TR cell.

Since the cell indices or other identities of the serving cells are known also by the wireless network 100, the wireless network 100 will know which serving cell is the new timing reference, i.e. the new TR cell. But in another scenario, a deactivated cell may be selected as the TR cell, i.e. the new TR cell. These embodiments may be a part of the autonomous reselection process terminal 120 performs as described in the embodiments above. For example, the cell with the lowest or highest cell index may be the new TR cell, i.e. new TR cell, and thus performing the random access is avoided.

According to some embodiments, a method in a network node such as the base station 110 for handling a timing reference is provided. The timing reference may be for UL transmissions by the terminal 120. The terminal 120 is served by multiple serving cells of the wireless network 100. The terminal 120 is configured with a first Timing Advance, TA, group comprising the multiple serving cells, one of which, a current TR cell, acts as the timing reference for the multiple serving cells, which multiple serving cells serve the terminal 120, and which multiple serving cells are comprised in a wireless network 100, the method comprising:

selecting 403 a new TR cell to act as the timing reference for the multiple serving cells in the TA group when the current TR cell becomes unavailable for the terminal 120.

In some embodiments, only activated serving cells are considered for being selected as the new TR cell.

In some embodiments, the selection of the new TR cell is based on unique cell identifiers of the respective serving cells still associated with the TA group after that the current TR cell has become unavailable to the terminal 120.

In some embodiments, this may be performed by sending information to the terminal 120 to start using said new TR cell for said TA group when or before the current TR cell becomes unavailable for the terminal 120.

In some embodiments, the unique cell identifier comprises a cell index, and the serving cell with the lowest or highest cell index is selected as the new TR cell.

In some embodiments, the network node provides a cell index or other indicator pointing out one of the remaining cells in the same TA group to the terminal 120.

The cell index or indicator may be provided as part of an existing deconfiguration or TA group-reconfiguration message to the terminal 120.

The new TR cell may be a cell belonging to the TA group or to another TA group.

In some embodiments, the new TR cell is a cell acting as timing reference in the TA group to which a primary serving cell belongs.

In a fourth embodiment, the wireless network 100 such as e.g. the base station 110 selects a new TR cell for a specific TA group. The base station 110 may inform the terminal 120 to start using said serving cell as TR cell, i.e. as the new TR cell for said TA group prior to removing, deconfiguring, or otherwise making the current TR cell being the current TR unavailable for use as a timing reference of the specific TA group.

The wireless network 100 such as e.g. the base station 110 may perform the reselection and inform the terminal 120. For example, the base station 110 or a combination of network nodes including core network nodes may perform the reselection, and the base station 110 may inform the terminal 120. The wireless network 100 may provide a cell index or other indicator pointing out one of the remaining cells in the same TA group to the terminal 120. The cell index or indicator may be provided as part of an existing deconfiguration or TA group-reconfiguration message to the terminal 120, thus informing the terminal 120 of the new serving cell, i.e. the new TR cell, to use as the TR cell. The terminal 120 may perform the switch to the new TR cell immediately upon being notified. In some embodiments, the new TR cell is an activated serving cell belonging to the TA group for which it is selected to be the timing reference.

The embodiments listed above may either be used as individual solutions or multiple embodiments may be used in combination as one solution. In addition to the specific TA group mentioned, the terminal 120 may be configured with one or more other TA groups.

In the current version of the standards, only activated serving cells may be used as a timing reference. However, the scope of the disclosed subject matter is not so limited. The disclosed subject matter is also valid in situations in which configured serving cells, including deactivated cells, could be used as a timing reference and could be associated with a TA group. The solution would also be valid in the case where the cell used as a timing reference for a specific TA group is not a member of said TA group.

The Terminal

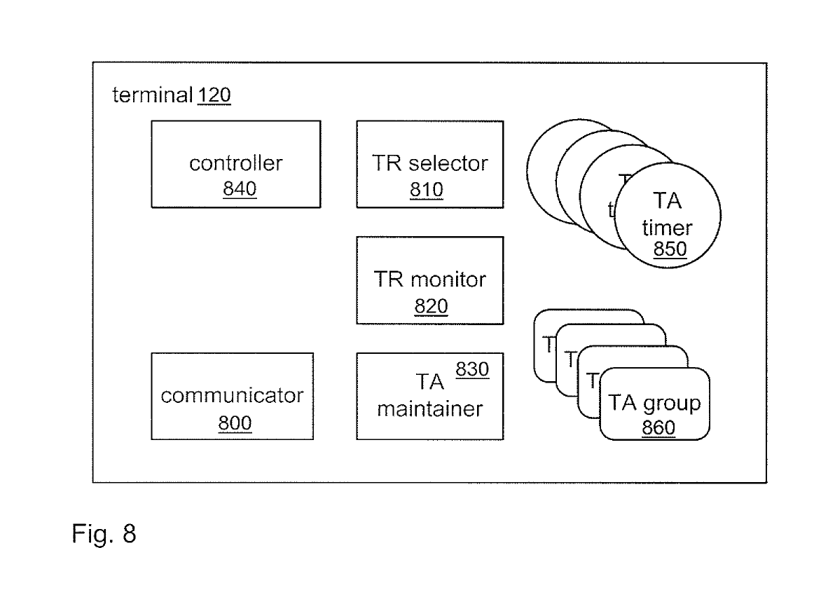

FIG. 8 illustrates an example of the terminal 120, e.g., a UE. As seen, the terminal 120 may comprise several devices including a communicator 800, a TR selector 810, a TR monitor 820, a TA maintainer 830, and a controller 840. Also shown are TA timer(s) 850 and a list of TA group(s) 860 maintained in the terminal 120.

The communicator 800 is structured to communicate with other network nodes such as base stations. In the context of this document, it can be said that the communicator 800 communicates with the cells of the wireless network 100. In some embodiments, the timing reference is for uplink transmissions on the multiple serving cells. In these embodiments, the communicator 800 may be configured to perform uplink transmissions in accordance with the selected timing reference.

The TR selector 810 is structured to select new TR cells for the TA groups, i.e. the new TR cell. More generally, the TR selector 810 is structured to establish a valid timing reference when needed.

The TR monitor 820 is structured to determine whether or not there is a valid timing reference for each TA group 860. The TR monitor 820 may stop the TA timer 850 of a TA group 860 or may consider the timer to be expired.

The TA maintainer 830 is structured to maintain the TA groups 860.

The controller 840 is structured to control an overall operation of the terminal 120.

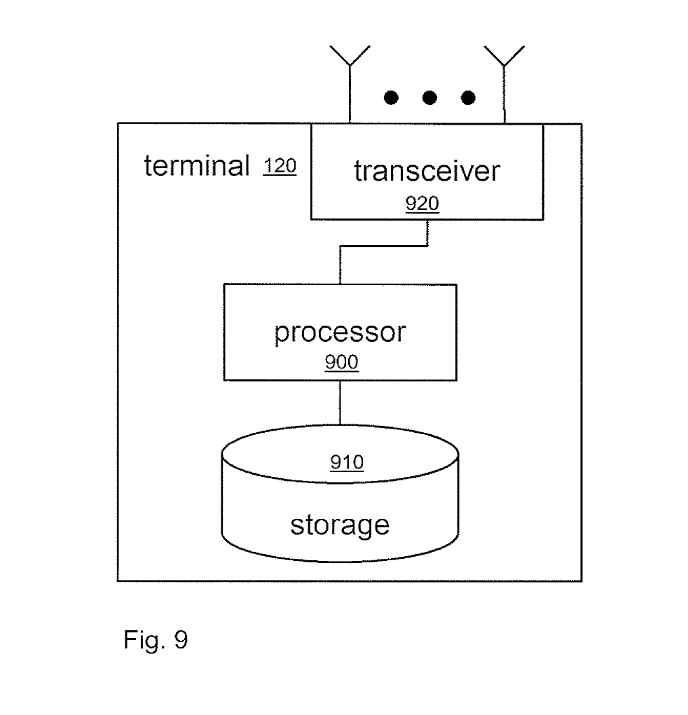

FIG. 8 provides a logical view of the terminal 120 and the devices included therein. It is not strictly necessary that each device be implemented as physically separate modules or circuits. Some or all devices may be combined in one physical module. Also, one or more devices may be implemented in multiple physical modules. The devices need not be implemented strictly in hardware. It is envisioned that any of the devices may be implemented through a combination of hardware and software as illustrated in FIG. 9.

For example, the terminal 120 may include one or more central processing units or processors such as the processor 900 in FIG. 9, executing program instructions stored in a non-transitory storage medium 910 or in firmware, e.g., Read-Only Memory (ROM), Random Access Memory (RAM), Flash, to perform the functions of the devices. The terminal 120 also includes a transceiver 920 structured to receive signals from the wireless network 100 and to send signals to the wireless network 100 over one or more antennas. A transmitter and a receiver may be implemented in the transceiver 920 as physically separate devices.

To perform the method actions for handling a timing reference described above, the terminal 120 comprises the following arrangement. The terminal 120 is adapted to be served by multiple serving cells of a wireless network 100. The terminal is adapted to be configured with a TA group comprising the multiple serving cells, one of which, a current TR cell, is configured to act as the timing reference for the multiple serving cells.

The timing reference selector 810 is configured to, when the current TR cell becomes unavailable for the terminal 120, autonomously select a new TR cell to act as the timing reference for the multiple serving cells in the TA group.

The current TR cell may become unavailable for the terminal 120 through deconfiguration, removal from the TA group, or deactivation.

The new TR cell may be a cell belonging to the TA group or a cell belonging to another TA group such as a second TA group. The new TR cell may be a cell acting as timing reference in the TA group to which a primary serving cell belongs.

In some embodiments, the timing reference selector further is configured to only consider activated serving cells for being selected as the new TR cell.

In some embodiments, the timing reference selector further is configured to select the new TR cell based on unique cell identifiers of the respective serving cells still associated with the TA group. The unique cell identifier may be represented by a cell index, In these embodiments, the timing reference selector 810 may further be configured to select the serving cell with the lowest or highest cell index as the new TR cell.

Network Node

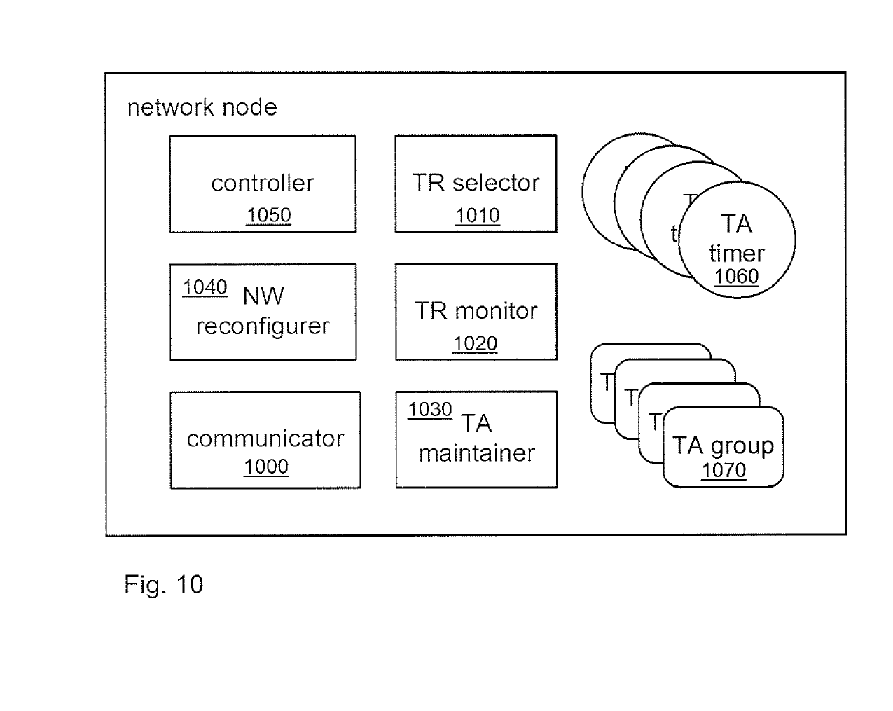

FIG. 10 illustrates an example of a network node such as the base station 110. As seen, the network node such as an eNodeB, or more generically the base station 110 or a core network node, may comprise several devices including a communicator 1000, a TR selector 1010, a TR monitor 1020, a TA maintainer 1030, a network reconfigurer 1040, and a controller 1050. Also shown are TA timer(s) 1060 and a list of TA group(s) 1070.

The communicator 1000 is structured to communicate with other network nodes, terminals such as the terminal 120 and to core network nodes.

The TR selector 1010 is structured to select a new TR cell for one or more terminals such as the terminal 120.

The TR monitor 1020 is structured to determine whether or not there is a valid timing reference for each TA group 1070 of each served terminal such as the terminal 120.

The TA maintainer 1030 is structured to maintain the TA groups 1070 and may also monitor the TA timer 1060 associated with each TA group 1070 of each served terminal and provide necessary TA value updates.

The NW reconfigurer 1040 is structured to reconfigure the cells of the wireless network 110, i.e. to reconfigure which cell is configured as a serving cell for each terminal such as the terminal 120.

The controller 1050 is structured to control an overall operation of the network node such as the base station 110.

Recall from above that each terminal 120 may have its own TA group configuration that specifies which TA groups the serving cells belong to. Thus, in one aspect, the wireless network 100 knows how the TA grouping is done in the terminal 120, and the wireless network keeps a copy of the TA group configuration specific to each terminal including the terminal 120.

The base station 110 or another network node may control the TA grouping of a terminal's serving cells. The base station 110 or the another network node may tell the terminal 120 which cell should be placed in which TA group. The base station 110 or another network node may also control which TA groups, i.e. which TA group cell indexes, that exists.

Furthermore, for each TA group 830, the terminal 120 may maintain a TA timer 850, and the wireless network 100 such as the base station 110 may keep track of the state of these timers 1060. For example, the wireless network 100 such as the base station 110 may maintain copies of each terminal's set of TA timers 850. The wireless network 100 such as the base station 110 may keep track of the TA timer 850 durations. In this way, the wireless network 100 such as the base station 110 may make sure to update the TA value for a TA group 1070 before the associated TA timer 1060 expires so as to keep the group in synch.

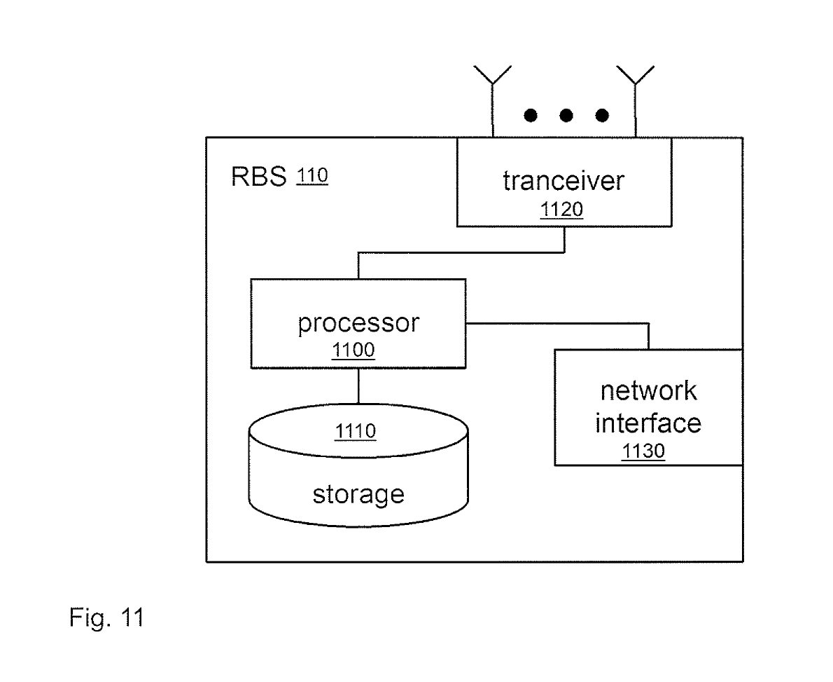

FIG. 10 provides a logical view of the network node such as the base station 110 and the devices included therein. It is not strictly necessary that each device be implemented as physically separate modules or circuits. Some or all devices may be combined in a physical module. Also, one or more devices may be implemented in multiple physical modules as illustrated in FIG. 11.

As seen in FIG. 11, the devices of the network node such as the base station 110 need not be implemented strictly in hardware. It is envisioned that any of the devices may be implemented through a combination of hardware and software. For example, the network node such as the base station 110 may include one or more central processing units or processors such as a processor 1100 executing program instructions stored in a non-transitory storage medium 1110 or in firmware, e.g., ROM, RAM, Flash, to perform the functions of the devices. The network node, in case of radio base stations such as the base station 110, also includes a transceiver 1120 structured to receive signals from the terminal 120 and to send signals to the terminal 120 over one or more antennas. The transmitter and the receiver may be implemented in the transceiver 1110 as physically separate devices. The network node such as the base station 110 may also include a network interface 1130 to communicate with other network nodes such as core network nodes.

A possible approach would be to assume that the network node, e.g., base station 110, is structured to ensure that it changes the timing reference of a TA group if it intends to remove, deactivate or deconfigure the current TR cell of the TA group in a terminal. But even if the network node is not so structured, aspects of the disclosed subject matter can protect the wireless network 100 from undesirable potentially unsynchronized UL transmissions.

The embodiments described herein thus provide one or more methods in a terminal, a terminal, one or more methods in network node, and a network node.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appended claims.

1: A method in a terminal for handling a timing reference, which terminal is served by multiple serving cells of a wireless network, which terminal is configured with a Timing Advance (TA) group comprising the multiple serving cells, one of which, a current Timing Reference cell (TR cell), acts as the timing reference for the multiple serving cells, the method comprising:
when the current TR cell becomes unavailable for the terminal, autonomously selecting a new TR cell to act as the timing reference for the multiple serving cells in the TA group, and stopping a TA timer in the terminal.

2: The method according to claim 1, wherein the current TR cell becomes unavailable for the terminal through deconfiguration, removal from the TA group, or deactivation.

3: The method according to claim 1, wherein the new TR cell is a cell belonging to the TA group.

4: The method according to claim 1, wherein the new TR cell is a cell belonging to another TA group.

5: The method according to claim 4, wherein a primary serving cell belongs to the another TA group.

6: The method according to claim 4, wherein the new TR cell is a cell acting as timing reference in the TA group to which a primary serving cell belongs.

7: The method according to claim 1, wherein only activated serving cells are considered for being selected as the new TR cell.

8: The method according to claim 1, wherein the selection of the new TR cell is based on unique cell identifiers of the respective serving cells still associated with the TA group.

9: The method according to claim 8, wherein the unique cell identifier comprises a cell index, and wherein the serving cell with the lowest or highest cell index is selected as the new TR cell.

10: The method according to claim 1, wherein the timing reference is for uplink transmissions on the multiple serving cells, the method further comprising performing uplink transmissions in accordance with the selected timing reference.

11: A terminal for handling a timing reference, which terminal is adapted to be served by multiple serving cells of a wireless network, which terminal is adapted to be configured with a Timing Advance (TA) group comprising the multiple serving cells, one of which, a current Timing Reference cell (TR cell), is configured to act as the timing reference for the multiple serving cells, and wherein:
the terminal comprises a timing reference selector configured to, when the current TR cell becomes unavailable for the terminal, autonomously select a new TR cell to act as the timing reference for the multiple serving cells in the TA group, and to stop a TA timer in the terminal.

12: The terminal according to claim 11, wherein the current TR cell becomes unavailable for the terminal through deconfiguration, removal from the TA group, or deactivation.

13: The terminal according to any claim 11, wherein the new TR cell is a cell belonging to the TA group.

14: The terminal according to claim 11, wherein the new TR cell is a cell belonging to another TA group.

15: The method according to claim 14, wherein a primary serving cell belongs to the another TA group.

16: The terminal according to claim 14, wherein the new TR cell is a cell acting as timing reference in the TA group to which a primary serving cell belongs.

17: The terminal according to claim 11, wherein the timing reference selector further is configured to only consider activated serving cells for being selected as the new TR cell.

18: The terminal according to claim 11, wherein the timing reference selector further is configured to select the new TR cell based on unique cell identifiers of the respective serving cells still associated with the TA group.

19: The terminal according to claim 18, wherein the unique cell identifier comprises a cell index, and wherein the timing reference selector further is configured to select the serving cell with a lowest or highest cell index as the new TR cell.

20: The method according to claim 11, wherein the timing reference is for uplink transmissions on the multiple serving cells, and wherein the terminal further comprises a communicator configured to perform uplink transmissions in accordance with the selected timing reference.

21: The method according to claim 1, further comprising:
performing a random access procedure towards the new TR cell.

22: The terminal according to claim 11, being further configured to perform a random access procedure towards the new TR cell.
